(19) United States
(12) Patent Application Publication
(10) Pub. No.: US 2021/0064670 A1
(43) Pub. Date: Mar. 4, 2021

(54) CUSTOMIZING AND UPDATING ANALYTICS OF REMOTE DATA SOURCE

(71) Applicant: Microsoft Technology Licensing, LLC, Redmond, WA (US)

(72) Inventors: Nikita MIDHA, Noida (IN); Kiran Shrinivasa KALYANTHAYA, Bangalore (IN); Bishal SAHOO, Bhubaneshwar (IN); Ragini PATEL, Raigarh (IN)

(21) Appl. No.: 16/554,213

(22) Filed: Aug. 28, 2019

(51) Int. Cl. G06F 16/903; G06F 16/9038

(52) U.S. Cl. CPC G06F 16/90335; G06F 16/9038

(57) ABSTRACT

Customizing and updating analytics of tenant data maintained at a remote data source. A tenant computing system causes a network connection to be established between a tenant analytics component of the tenant and a data source that contains tenant data of the tenant. The tenant may then use an analytics customization interface of a tenant analytics component to customize the analytics. The tenant customization interface permits a metric of the tenant data to be viewed across one or more query dimensions that are defined by the analytics customization input and that are permitted by a data model of the tenant data, The data model of the tenant data is maintained by the data source. As an example, the data source may notify the tenant analytics component of the available query dimensions over the network connection.

### BACKGROUND

Online data services are often used to store data for multiple customers (also called tenants). The online data services maintain trust boundaries so that tenants only have access to their own data. Furthermore, online data services also permit tenants to perform analytics on their tenant data. Thus, analytics may be performed on the tenant data remotely on the online data service, and then the analytics are returned to the tenant for evaluation. Alternatively, the analytics may be performed locally on the tenant data after the tenant downloads the tenant data.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

Embodiments disclosed herein relate to customizing and updating analytics of tenant data maintained at a remote data source. A tenant computing system causes a network connection to be established between a tenant analytics component of the tenant and a data source that contains tenant data of the tenant. The remote data source includes a data source in which tenant data changes in response to at least one real-time data feed. The tenant may then use a tenant analytics component to customize the analytics.

For instance, a tenant user may input analytics customization via a customization interface of the tenant analytics component. The tenant customization interface permits a metric of the tenant data to be viewed across one or more query dimensions that are defined by the analytics customization input and that are permitted by a data model of the tenant data. The data model of the tenant data is maintained by the data source. As an example, the data source may notify the tenant analytics component of the available query dimensions over the network connection. For instance, as the data model changes, the data source notifies the tenant analytics component of the new data model.

The tenant computing system then uses the customization input to generate one or more queries of the metric along the one or more query dimensions. These query(s) are then caused to be transmitted to the data source over the network connection. The analytics component then uses the one or more query responses to cause analytics associated with the metric to be presented along the one or more query dimensions. As examples, customizations of the analytics might include changing the query dimensions, changing the way that a metric is calculated, changing a visualization used to render the metric to the user, and/or even adding a new metric.

For instance, the data source might be fed by one or more real-time feeds such that the tenant data is real-time tenant data. In this case, the query responses may be updated over the network connection as the corresponding tenant data changes, allowing the user to view the updated analytics. The network connection is a secure connection enabled via an application that is trusted to the data source and the tenant analytics component. Accordingly, the principles described herein permit for a tenant to customize and update analytics of their tenant data without requiring the tenant maintain the data source that contains the tenant data. Furthermore, the tenant analytics component and the data source have a secure connection thereby enabling the queries and associated responses to be secure, thereby continuing to protect the tenant data, and more, so that the data source may contain data of other tenants as well as service data to multiple tenants.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates a network environment in which the principles described herein may be employed, and which includes a data source computing system and multiple tenant computing systems communicating over a network;

FIG. 2 illustrates a more general correlation in which different metrics may be queried along different dimensions;

FIG. 3 illustrates a flowchart of a method for customizing analytics of tenant data maintained at a remote data source, in accordance with the principles described herein;

FIG. 4 illustrates a structure of a tenant analytics component, which represents an example of the analytics components of FIG. 1;

FIG. 5 illustrates a data source that represents an example of the data source of FIG. 1;

FIG. 6 illustrates an environment in which a data source computing system may use a trusted application in order to establish a secure network connection with a tenant analysis component; and

FIG. 7 illustrates an example computing system in which the principles described herein may be employed.

### DETAILED DESCRIPTION

Embodiments disclosed herein relate to customizing and updating analytics of tenant data maintained at a remote data source. A tenant computing system causes a network connection to be established between a tenant analytics component of the tenant and a data source that contains tenant data of the tenant. The remote data source includes a data source in which tenant data changes in response to at least one real-time data feed. The tenant may then use a tenant analytics component to customize the analytics.

For instance, a tenant user may input analytics customization via a customization interface of the tenant analytics component. The tenant customization interface permits a metric of the tenant data to be viewed across one or more query dimensions that are defined by the analytics customization input and that are permitted by a data model of the tenant data. The data model of the tenant data is maintained by the data source. As an example, the data source may notify the tenant analytics component of the available query dimensions over the network connection. For instance, as the data model changes, the data source notifies the tenant analytics component of the new data model.

The tenant computing system then uses the customization input to generate one or more queries of the metric along the one or more query dimensions. These query(s) are then caused to be transmitted to the data source over the network connection. The analytics component then uses the one or more query responses to cause analytics associated with the metric to be presented along the one or more query dimensions. As examples, customizations of the analytics might include changing the query dimensions, changing the way that a metric is calculated, changing a visualization used to render the metric to the user, and/or even adding a new metric.

For instance, the data source might be fed by one or more real-time feeds such that the tenant data is real-time tenant data. In this case, the query responses may be updated over the network connection as the corresponding tenant data changes, allowing the user to view the updated analytics. The network connection is a secure connection enabled via an application that is trusted to the data source and the tenant analytics component. Accordingly, the principles described herein permit for a tenant to customize and update analytics of their tenant data without requiring the tenant maintain the data source that contains the tenant data. Furthermore, the tenant analytics component and the data source have a secure connection thereby enabling the queries and associated responses to be secure, thereby continuing to protect the tenant data, and more, so that the data source may contain data of other tenants as well as service data to multiple tenants.

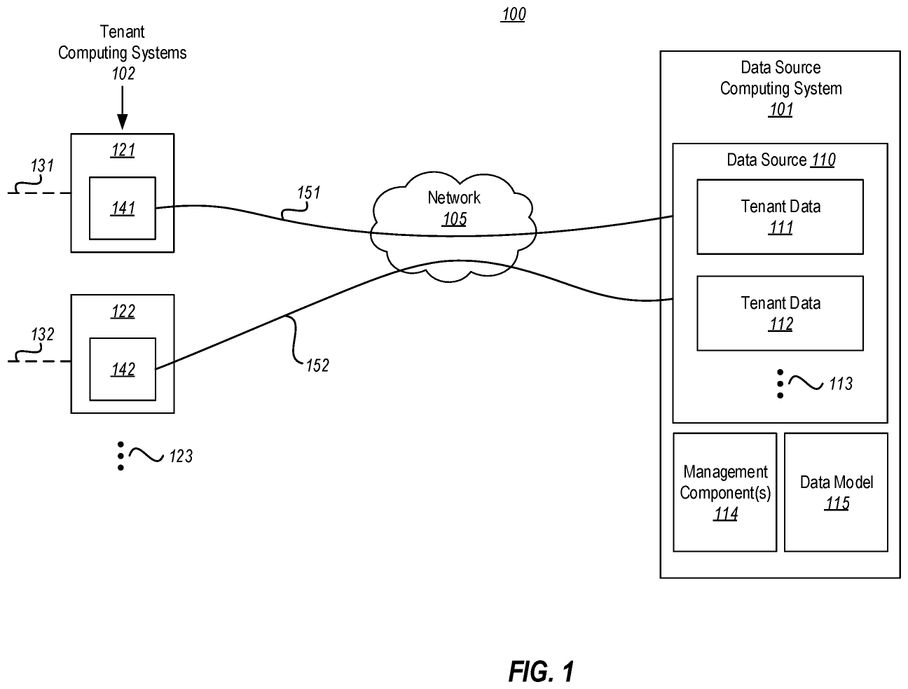

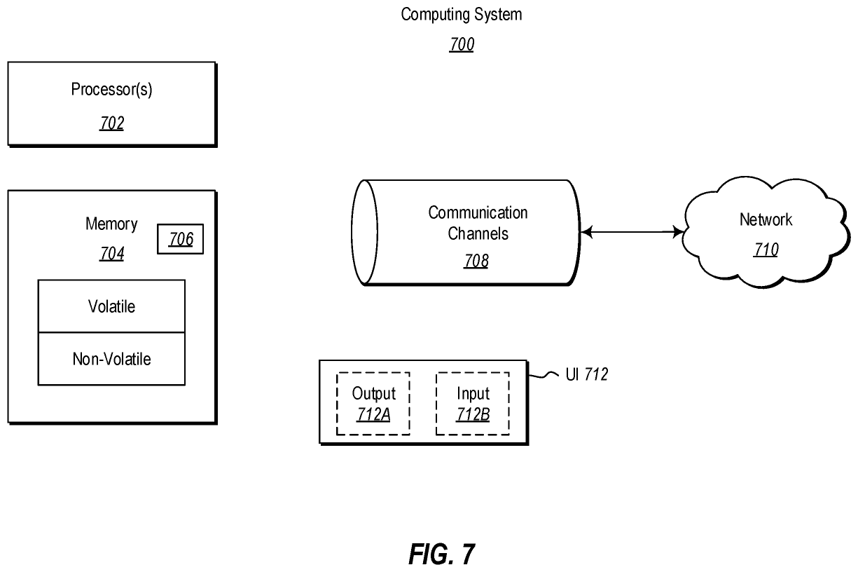

FIG. 1 illustrates a network environment 100 in which the principles described herein may be employed. The network environment 100 includes a data source computing system 101 and multiple tenant computing systems 102. The data source computing system 101 and each of the tenant computing systems 102 may be structured as described below for the computing system 700 of FIG. 7. The data source computing system 101 is connectable to each of the tenant computing systems 102 via a network 105. As an example, the network 105 may be the Internet, and the data source computing system 101 may be a cloud data service that serves multiple tenants.

The tenant computing systems 102 may include any number of tenant computing systems as represented by the ellipsis 123, two of which being expressly illustrated as tenant computing system 121 and tenant computing system 122. The data source computing system 101 manages a data source 110 that includes tenant data belonging to each tenant. For instance, the data source computing system 101 manages tenant data 111 belonging to a first tenant 131 associated with the tenant computing system 121, tenant data 112 belonging to a second tenant 132 associated with the tenant computing system 122, and so forth as represented by the ellipsis 113 for each of potentially other tenants.

The data source computing system 101 includes one or more data management components 114 that manages each of the tenant data. If the data source computing system 101 is structured as described below for the computing system 700 of FIG. 7, each of the one or more data management components 114 may be structured as described below for the executable component 706 of FIG. 7.

The tenant data is organized in accordance with a data model 115. In one embodiment, the tenant data for each tenant has the same data model (e.g., data model 115). Alternatively, the tenant data for each tenant might have different data models. As a yet further alternative, the tenant data for some tenants have the same data model, whereas the tenant data for other tenant(s) might each have different data models. In any case, for any given tenant, the tenant data is organized in accordance with a data model.

The data model 115 defines the query dimensions against which a metric may be queried. For instance, suppose that the tenant data includes entries for customer service requests received by a particular tenant. A metric of that tenant data might be the call handling time. The data model might permit the call handling time to be viewed across a variety of different dimensions. For instance, the call handling time might be viewed per call agent that handled the call, per product that the call pertains to, per call center, per region that the call originated from, per region of the call center, per call satisfaction rating, and so forth for whatever the data model supports for that metric.

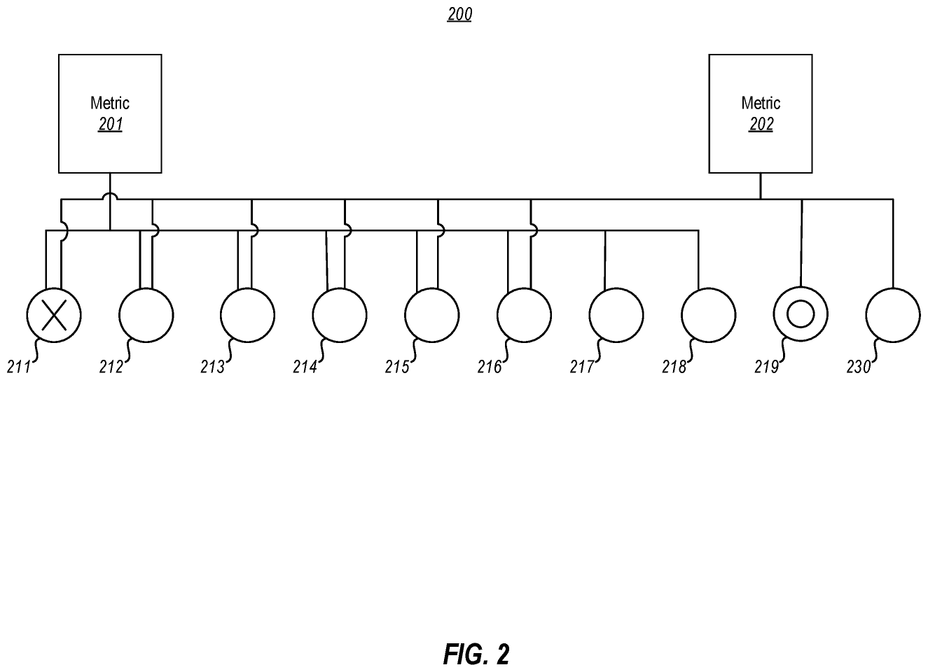

FIG. 2 illustrates a more general correlation 200 in which a metric 201 may be queried along the dimensions 211 through 218, and metric 202 may be queried along dimensions 211 through 216, 219 and 220. In one embodiment, there are default dimensions that, absent customization by a user of the tenant, the metric may be queried against. For instance, in FIG. 2, the query dimension 211 might be used as a default when analyzing the metric 201, as symbolized by the query dimension 211 containing a capital “X”. As an example, if the metric is call handling time, the default query dimension might be the call agent, thereby allowing (without further customization) querying of each call agent's call handling time. In FIG. 2, the query dimension 219 might be used as a default when analyzing the metric 202, as symbolized by the query dimension 219 containing a capital “O”. As an example, if the metric is the call satisfaction rating, the default query dimension might be the call center, thereby allowing (without further customization) querying of the call satisfaction ratings of each call center.

The tenant computing system 121 includes a tenant analytics component 141 that permits a user of the first tenant 131 to perform analytics on the first tenant data 111. Likewise, the tenant computing system 122 includes a tenant analytics component 142 that permits a user of the second tenant 132 to perform analytics on the second tenant data 112. In the case of the tenant computing system 121 being structured as described below for the computing system 700, then the tenant analytics component 141 may be structured as described below for the executable component 706 of FIG. 7. In the case of the tenant computing system 122 being structured as described below for the computing system 700, then the tenant analytics component 142 may be structured as described below for the executable component 706 of FIG. 7.

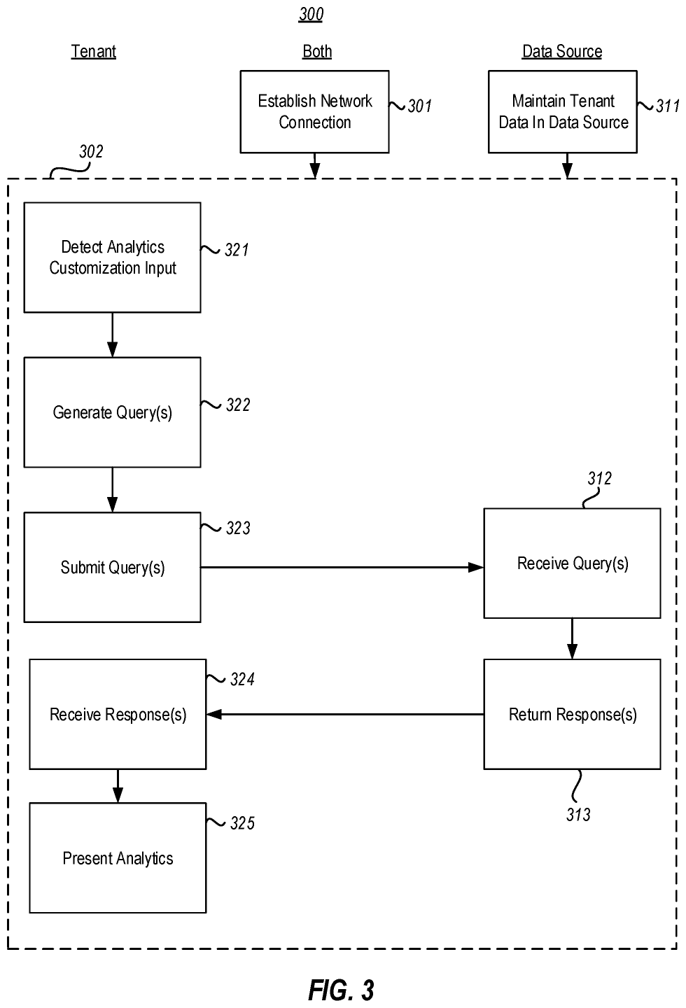

FIG. 3 illustrates a flowchart of a method 300 for customizing analytics of tenant data maintained at a remote data source. As the method 300 may be performed in the context of the network environment 100 of FIG. 1, and with the data model 115 having the correlations 200 of FIG. 2, the method 300 will now be described with respect to FIGS. 1 through 3.

In an example referred to herein as the “first tenant example,” the method 300 is performed collaboratively by the tenant computing system 121 and the data source computing system 101, so that a user of the first tenant 131 can perform analytics on the first tenant data 111. In another example referred to herein as the “second tenant example,” the method 300 is performed collaboratively by the tenant computing system 122 and the data source computing system 101 so that a user of the second tenant 132 can perform analytics on the second tenant data 112. Both of these examples will be described.

In each of the first and second tenant examples, some of the acts will be performed by a data source computing system (e.g., data source computing system 101) and are represented in the right column of FIG. 3 under the heading “Data Source”. Some of the acts will be performed by a tenant computing system such as the tenant computing system 121 in the first tenant example, and the tenant computing system 122 in the second tenant example, and are illustrated in the left column of FIG. 3 under the heading “Tenant”. Acts that are performed collaboratively by both the data source computing system and the tenant computing system are listed in the middle column of FIG. 3 under the heading “Both”.

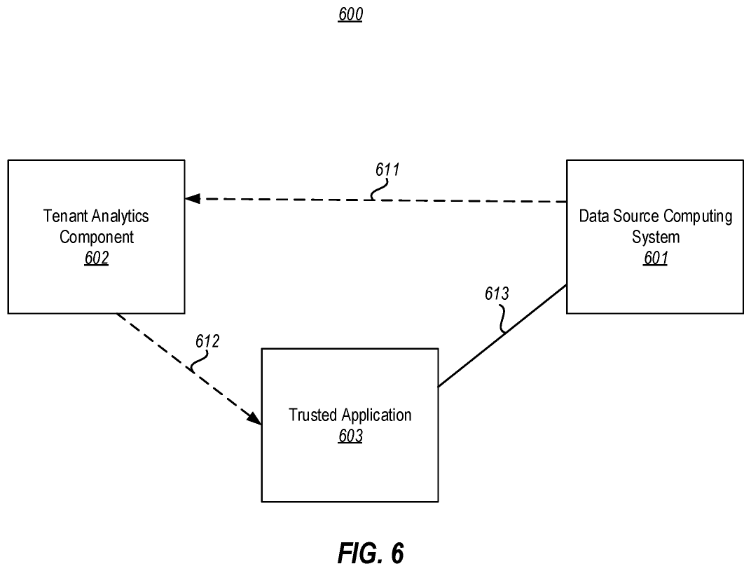

The method 300 includes causing a network connection to be established between a tenant analytics component of a tenant and a data source that contains tenant data of the tenant (act 301). For instance, in FIG. 1, with respect to the first tenant example, the network connection 151 is established. With respect to the second tenant example, the network connection 152 is established. More regarding how the network connection can be securely established will be described with respect to FIG. 6. By having a secure connection between the tenant computing system and the data source computing system, the queries and responses communicated over the network connection remain secure, and thus the tenant data itself also remains secure. This makes possible the separation of the tenant analytics component from the tenant data.

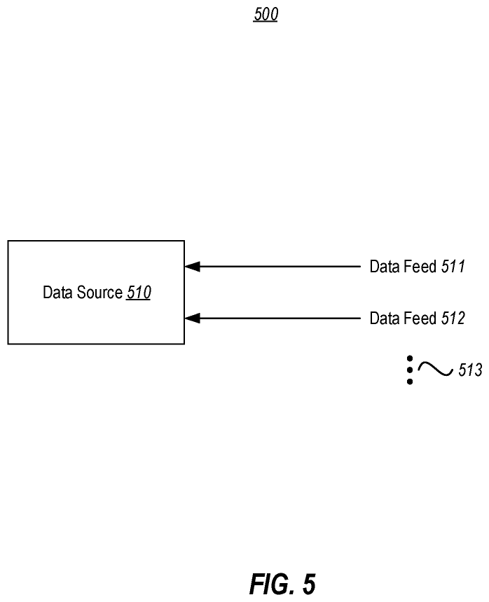

The method 300 also includes the data source maintaining tenant data of a tenant in accordance with a data model (act 311). For instance, in FIG. 1, with respect to the first tenant example, the data source computing system 101 maintains tenant data 111 using management component(s) 114. With respect to the second tenant example, the data source computing system 101 maintains tenant data 112 also using management component(s) 114. More regarding how the data source may maintain the tenant data in real-time will be described with respect to FIG. 5. The remainder of the method 300 is shown inside dashed-lined box 302, which may be performed one or more times for a given network connection.

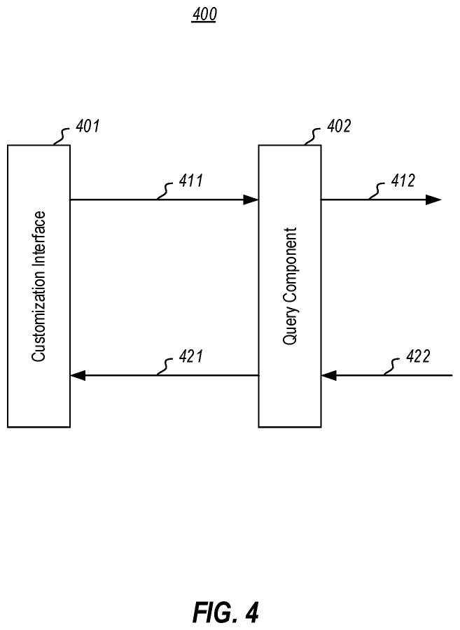

The method 300 includes detecting receipt of analytics customization input via a customization interface of the tenant analytics component (act 321). For instance, FIG. 4 illustrates a structure of a tenant analytics component 400, which represents an example of the analytics component 141 of FIG. 1 for the first tenant example, and which represents an example of the analytics component 142 of FIG. 1 for the second tenant example. The tenant analytics component 400 includes a customization interface 401, which receives the customization input. The tenant customization interface 401 permits a metric of the tenant data to be viewed across one or more query dimensions that are defined by the analytics customization input.

As an example, the customization interface may permit one or more query dimensions of the tenant data to be changed as permitted by the data model of the tenant data. In that case, the analytics customization input may change the query dimension(s) that are to be queried against for the metric. For instance, in FIG. 2, the query dimension 211 (e.g., per call agent) might be used as a default when analyzing the metric 201 (e.g., call handling time). However, so long as the data model of the tenant data permits, the customization input may modify the query dimensions. For example, in FIG. 2, the query dimension 211 may be changed to the query dimension 212 (e.g., call center) when analyzing the metric 201 (e.g., call handling time).

As another example, the customization interface may permit a calculation of the metric to be altered. For instance, in the example in which the tenant data includes call information, the metric may be the call handling time. The very method used to calculate the call handling time may be changed. For example, the calculation of the call handling time might be changed so as to include call wait time that occurs when the caller is waiting to be connected to a call agent.

As a third example, the customization interface may permit at least one additional metric of the tenant data to be defined. For instance, the user of the tenant might define a new metric—caller satisfaction. In addition, the tenant customization input might specify what query dimensions may be queried against for the new metric—caller satisfaction. As a final example, the customization interface may permit a visualization associated with the metric to be changed.

Returning to the method 300 of FIG. 3, the tenant analytics component then uses the customization input to generate one or more queries of the metric along the applicable one or more query dimensions (act 322). Referring to FIG. 2, the query component 402 might use the customization input (as represented by arrow 411) to generate one or more queries. For instance, if the customization input changes the query dimension for the call handling time metric from a per agent dimension to a per call center dimension, a query may be generated that queries for call handling time per call center (or per call center, queries for relevant input data from which the call handling time may be calculated). Since the data model of the tenant data permits this change in query dimensions, a query may be formed that the data source computing system will be able to interpret and generate an appropriate response.

The tenant computing system then causes the one or more queries (as represented by arrow 412) to be transmitted to the data source over the network connection (act 323). Referring to FIG. 1, in the first tenant example, the tenant computing system 121 transmits the query(s) to the data source computing system 101 over the connection 151. In the second tenant example, the tenant computing system 122 transmits the query(s) to the data source computing system 101 over the connection 152.

The data source computing system then receives the query(s) (act 312). The data source computing system 101 then assesses the query(s) against the relevant tenant data to generate one or more query responses, and then returns those query response(s) to the appropriate tenant computing system (act 313).

For instance, in the first tenant example, the tenant analytics component 141 submits the query via the network connection 151 to the data source computing system 101. The data management component(s) 114 then assesses the query(s) against the tenant data 111 to generate query response(s). The data source computing system 101 then returns those query response(s) over the network connection 151 to the tenant computing system 121 for handling by the tenant analytics component 141. Furthermore, if the one or more query response(s) are to be updated in response to changes to tenant data, the data source computing system 101 may also return those updates over the network connection 151 to the tenant computing system 121 for handling by the tenant analytics component 141.

In the second tenant example, the tenant analytics component 142 submits the query via the network connection 152 to the data source computing system 101. The data management component(s) 114 then assesses the query(s) against the tenant data 112 to generate query response(s). The data source computing system 101 then returns those query response(s) over the network connection 152 to the tenant computing system 122 for handling by the tenant analytics component 142. Furthermore, if the one or more query response(s) are to be updated in response to changes to tenant data, the data source computing system 101 may also return those updates over the network connection 152 to the tenant computing system 122 for handling by the tenant analytics component 142.

The tenant computing system then receives the query response(s) (and their updates) via the network connection (act 324). The tenant analytics component detects that receipt. For instance, referring to FIG. 4, the query component 402 detects receipt (as represented by arrow 422) of the query response(s). In response, the tenant analytics component uses the one or more query responses to cause analytics associated with the metric to be presented along the one or more query dimensions (act 325). This also causes the analytics to be updated with updates to the query response(s) are received. For instance, referring to FIG. 4, the customization interface 401 causes (as represented by arrow 421) the analytics associated with the metric to be presented along the query dimension(s) to the user of the tenant. This may involve computation of the analytics from the query response(s). Thus, the user of a tenant may customize the analytics by changing the query dimensions associated with a metric of the tenant data, changing how a metric of the tenant data is calculated, adding new metrics for the tenant data, or changing a visualization of the tenant data.

The content of the box 302 may be performed multiple times even for the very same connection. Thus, in the first tenant example, a user of the first tenant computing system 121 may re-customize analytics of the first tenant data 111 any number of times (e.g., each time new analytics customization input is provided to the tenant analytics component 141) during the lifetime of the network connection 151. Likewise, in the second tenant example, a user of the second tenant computing system 122 may re-customize analytics of the second tenant data 112 any number of times (e.g., each time new analytics customization input is provided to the tenant analytics component 142) during the lifetime of the network connection 152.

FIG. 5 illustrates a data source environment that includes a data source 510 that represents an example of the data source 110 of FIG. 1. Here, the data source 510 is a real-time data source that is a target for one or more live data feeds. For instance, the data source 510 is illustrated as being fed by two live data feeds 511 and 512. However, the ellipsis 513 represents that the data source 500 may be fed by any number of live data feeds. The live data feeds may come from any type of source. Each live data feed may be monitored by an event component that generates an event when there is data encountered that affects any of the tenant data. When an event is encountered, the data source may alter the appropriate tenant data.

FIG. 6 illustrates an environment 600 in which a data source computing system 601 may use a trusted application 603 in order to establish a secure network connection with a tenant analysis component 602. For instance, in the first tenant example, the data source computing system 601 might be the data source computing system 101 and the tenant analysis component 602 might be the tenant analysis component 141. For instance, in the second tenant example, the data source computing system 601 might be the data source computing system 101 and the tenant analysis component 602 might be the tenant analysis component 142.

As part of establishing the network connection between the tenant analytics component 602 and the data source computing system 601 (e.g., act 301 of FIG. 3), the data source computing system 601 instructs (as represented by arrow 611) the tenant analytics component 602 to provide one or more access permissions to the trusted application 603. The tenant analytics component 602 then provides one or more access permissions to the trusted application 603 (as represented by arrow 612). This establishes trust between the tenant analytics component 602 and the trusted application 603. Furthermore, there was already trust (as represented by the solid line 613) between the trusted application 603 and the data source computing system 601. Thus, the trusted application 603 may now be used to securely intermediate queries and query responses between the tenant analytics component 602 and the data source computing system 601. Thus, a secure connection is established between the tenant analytics component 602 and the data source computing system 601.

Accordingly, the principles described herein provide a substantial improvement in the art of performing analytics on tenant data. Here, the analytics component that may be used to customize and update analytics may be separated over a network from the data source that manages the tenant data. Thus, the tenant computing system need not be concerned with management of data, but may rather allow for customization of the analytics in accordance with the data model of the tenant data. Furthermore, this may be done without sacrificing security since the queries and query responses are communicated over a secure connection. Finally, the data source may be a real-time data source.

As previously mentioned, some of the systems described above may be implemented by computing systems. Accordingly, a computing system will be described below with respect to FIG. 7. In that case, the functionality of the system may be performed by the computing system executing computer-executable instructions that are on one or more computer-readable media of the computing system, the computer-executable instructions being structured such that, when executed by the one or more processors of the computing system, the computing system is caused to perform the operations described herein.

Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 7, in its most basic configuration, a computing system 700 typically includes at least one hardware processing unit 702 and memory 704. The processing unit 702 may include a general-purpose processor and may also include a field programmable gate array (FPGA), an application specific integrated circuit (ASIC), or any other specialized circuit. The memory 704 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 700 also has thereon multiple structures often referred to as an “executable component”. For instance, the memory 704 of the computing system 700 is illustrated as including executable component 706. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard-coded or hard-wired logic gates. The computer-executable instructions (and the manipulated data) may be stored in the memory 704 of the computing system 700. Computing system 700 may also contain communication channels 708 that allow the computing system 700 to communicate with other computing systems over, for example, network 710.

While not all computing systems require a user interface, in some embodiments, the computing system 700 includes a user interface system 712 for use in interfacing with a user. The user interface system 712 may include output mechanisms 712A as well as input mechanisms 712B. The principles described herein are not limited to the precise output mechanisms 712A or input mechanisms 712B as such will depend on the nature of the device. However, output mechanisms 712A might include, for instance, speakers, displays, tactile output, virtual or augmented reality, holograms and so forth. Examples of input mechanisms 712B might include, for instance, microphones, touchscreens, virtual or augmented reality, holograms, cameras, keyboards, mouse or other pointer input, sensors of any type, and so forth.

Embodiments described herein may comprise or utilize a special-purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then be eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special-purpose computing system, or special-purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For the processes and methods disclosed herein, the operations performed in the processes and methods may be implemented in differing order. Furthermore, the outlined operations are only provided as examples, an some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

What is claimed is:

1. A tenant computing system comprising:
one or more processors; and
one or more computer-readable media having thereon computer-executable instructions that are structured such that, when executed by the one or more processors, cause the tenant computing system to perform a method for customizing and updating analytics of tenant data maintained at a remote data source, the method comprising:
an act of causing a network connection to be established between a tenant analytics component of a tenant and a data source that contains tenant data of the tenant;
an act of detecting receipt of analytics customization input via a customization interface of the tenant analytics component, the customization interface permitting a metric of the tenant data to be viewed across one or more query dimensions that are defined by the analytics customization input and that are permitted by a data model of the tenant data;
an act of using the customization input to perform an act of generating one or more queries of the metric along the one or more query dimensions;
an act of causing the one or more queries to be transmitted to the data source over the network connection;
an act of detecting receipt from the network connection of one or more query responses to the one or more queries, the one or more query responses being updated according to changes in the tenant data; and
an act of using the one or more query responses and their updates to perform an act of causing analytics associated with the metric to be presented along the one or more query dimensions.

2. The tenant computing system in accordance with claim 1, the data model of the tenant data permitting the metric to be queried along a number of metric-specific dimensions, the one or more query dimensions permitted by the data model in that the one or more query dimensions are included amongst the number of metric-specific dimensions.

3. The tenant computing system in accordance with claim 1, the act of causing analytics associated with the metric to be presented comprises changing the presentation as the one or more query responses are updated.

4. The tenant computing system in accordance with claim 1, the act of establishing the secure network connection being performed using a trusted application that is trusted by the data source and the tenant analytics component,
and as part of the act of establishing the network connection, the tenant analytics component provides one or more access permissions to the trusted application.

5. The tenant computing system in accordance with claim 1, the customization interface permitting the one or more query dimensions of the tenant data to be changed as permitted by the data model of the tenant data.

6. The tenant computing system in accordance with claim 1, the customization interface permitting a calculation of the metric to be altered.

7. The tenant computing system in accordance with claim 1, the customization interface permitting at least one additional metric of the tenant data to be defined.

8. The tenant computing system in accordance with claim 1, the act of causing analytics associated with the metric to be presented along the one or more query dimensions being performed using a visualization, the customization interface permitting the visualization used to present the metric to be changed.

9. A method for customizing and updating analytics of tenant data maintained at a remote data source, the method comprising:
an act of causing a network connection to be established between a tenant analytics component of a tenant and a data source that contains tenant data of the tenant;
an act of detecting receipt of analytics customization input via a customization interface of the tenant analytics component, the customization interface permitting a metric of the tenant data to be viewed across one or more query dimensions that are defined by the analytics customization input and that are permitted by a data model of the tenant data;
an act of using the customization input to perform an act of generating one or more queries of the metric along the one or more query dimensions;
an act of causing the one or more queries to be transmitted to the data source over the network connection;
an act of detecting receipt from the network connection of one or more query responses to the one or more queries, the one or more query responses being updated according to changes in the tenant data; and
an act of using the one or more query responses and the updates of the one or more query responses to perform an act of causing analytics associated with the metric to be presented along the one or more query dimensions.

10. The method in accordance with claim 9, the analytics customization input being first analytics customization input, the one or more query dimensions being first one or more query dimensions, the metric being a first metric,
an act of detecting receipt of second analytics customization input via the customization interface of the tenant analytics component, the customization interface permitting a second metric of the tenant data to be viewed across second one or more query dimensions that are defined by the analytics customization input and that are permitted by the data model of the tenant data;
an act of using the second customization input to perform an act of generating one or more queries of the second metric along the second one or more query dimensions;
an act of causing the one or more queries of the second metric to be transmitted to the data source over the network connection;
an act of detecting receipt from the network connection of one or more query responses to the one or more queries of the second metric, the one or more query responses to the one or more queries of the second metric being updated according to changes in the data tenant; and
an act of using the one or more query responses to the one or more queries of the second metric to perform an act of causing analytics associated with the second metric to be presented along the second one or more query dimensions.

11. The method in accordance with claim 9, the act of causing a network connection to be established being performed using a trusted application that is trusted by the data source and the tenant analytics component,
and as part of the act of establishing the network connection, the tenant analytics component provides one or more access permissions to the trusted application.

12. The method in accordance with claim 9, the customization interface permitting the one or more query dimensions of the tenant data to be changed as permitted by the data model of the tenant data.

13. The method in accordance with claim 12, the customization interface further permitting a calculation of the metric to be altered.

14. The method in accordance with claim 13, the customization interface permitting at least one additional metric of the tenant data to be defined.

15. The computing system in accordance with claim 9, the act of causing analytics associated with the metric to be presented along the one or more query dimensions being performed using a visualization, the tenant customization interface permitting the visualization used to present the metric to be changed.

16. A data source computing system comprising:
one or more processors; and
one or more computer-readable media having thereon computer-executable instructions that are structured such that, when executed by the one or more processors, cause the data source computing system to perform a method for customizing and updating analytics of tenant data for a tenant, the method comprising:
an act of maintaining, in a data source, tenant data of a tenant in accordance with a data model;
an act of causing a network connection to be established with a tenant analytics component of the tenant;
an act of detecting receipt, from the tenant analytics component and over the network connection, one or more queries of a metric of the tenant data along the one or more query dimensions, the one or more query dimensions being permitted by the data model of the tenant data; and
an act of responding, over the network connection to the one or more queries with one or more query responses and one or more updates to the one or more query responses according to changes in the data tenant.

17. The data source computing system in accordance with claim 16, the data source being a target for at least one real-time data feed that includes data that can change the tenant data.

18. The data source computing system in accordance with claim 16, the data source being a target for multiple real-time data feeds that include data that can change the tenant data.

19. The data source computing system in accordance with claim 16, the act of establishing the network connection being performed using a trusted application that is trusted by the data source computing system and the tenant analytics component,
and as part of the act of establishing the network connection, the data source computing system instructs tenant analytics component to provide provides one or more access permissions to the trusted application.

20. The data source computing system in accordance with claim 16, the computing system being configured to perform the method for multiple tenants.
